(19) United States
(12) Patent Application Publication
(10) Pub. No.: US 2005/0104395 A1
(43) Pub. Date: May 19, 2005

(54) Agricultural device having changeable tools

(76) Inventor: Shih Hao Hsu, Taichung (TW)

Correspondence Address: Shih Hao Hsu, P. O. Box 63-99, Taichung, 406, TW

(21) Appl. No.: 10/714,383

(22) Filed: Nov. 13, 2003

(51) Int. Cl. A01B 1/22

(52) U.S. Cl. 294/50.7

(57) ABSTRACT

An agricultural device includes a base having one or more orifices to receive one or more pins of gardening tools. A latch is slidably attached to the base to detachably latch the gardening tool to the base, and to allow one or more gardening tools to be quickly changed or replaced with the other ones. A guide member may be secured to the base, to guide the latch to move relative to the base. A hand grip may be slidably attached to the base to operate the gardening tool. A stop may be secured to the base to guide the latch to move relative to the base. A spring may be attached to the base, to bias the latch relative to the base.

### BACKGROUND OF THE INVENTION

1. Field of the Invention

The present invention relates to an agricultural device, and more particularly to an agricultural device having one or more changeable gardening tools.

2. Description of the Prior Art

Various kinds of typical agricultural devices have been developed and comprise a gardening tool attached to a bottom portion of a handle or the like, for being operated to cut or dig into soil, for weed removing purposes, or the like.

For example, U.S. Pat. No. 4,585,072 to Martinez discloses one of the typical agricultural devices including a gardening tool having a cutting chamber provided in the bottom portion of a handle, for being operated to cut or dig into soil, and including a plug ejector for removing the soil from the cutting chamber of the gardening tool. However, the gardening tool may not be disengaged from the handle, and thus may not be easily replaced with the other gardening tools.

U.S. Pat. No. 4,706,582 to Keskilohko discloses another typical agricultural device also including a gardening tool attached to the bottom portion of a handle, for being operated to dig into soil or for planting purposes. However, the gardening tool is solidly secured to the handle, and thus also may not be disengaged from the handle, and thus may not be easily replaced with the other gardening tools.

Similarly, U.S. Pat. No. 4,905,768 to Lorenz, and U.S. Pat. No. 5,234,241 to Ikerd also disclose two further typical agricultural devices each including a gardening tool attached to the bottom portion of a handle, for being operated to dig into soil or for weed removing purposes. However, the gardening tools are also solidly secured to the handle, and thus also may not be disengaged from the handle, and thus may not be easily replaced with the other gardening tools.

U.S. Pat. No. 5,865,259 to Catto discloses a still further typical agricultural device also including a hollow cylindrical cutter attached to the bottom portion of a handle, for being operated to dig into soil or for planting purposes. Similarly, the hollow cylindrical cutter may not be easily disengaged from the handle, and thus may not be easily replaced with the other gardening tools.

The applicant has thus developed another typical agricultural device, which is issued as U.S. Pat. No. 6,349,776 to Hsu, and which includes one or more tool members to be detachably and changeably attached to the bottom portion of a handle. However, a complicated structure is required for detachably and changeably attaching the tool members to the bottom portion of the handle, and is adverse for manufacturing and assembling purposes, and is expensive for manufacturing.

The present invention has arisen to mitigate and/or obviate the afore-described disadvantages of the conventional agricultural devices.

### SUMMARY OF THE INVENTION

The primary objective of the present invention is to provide an agricultural device including one or more gardening tools that may be easily changed or replaced with the other ones.

In accordance with one aspect of the invention, there is provided an agricultural device comprising a base including at least one orifice formed therein, a gardening tool including a plate having at least one pin extended therefrom, and engageable through the orifice of the base, and a latch to detachably latch the gardening tool to the base, and thus to secure the gardening tool to the base. One or more gardening tools may thus be easily and quickly changed or replaced with the other ones.

The pin of the plate of the gardening tool includes a peripheral groove formed therein, the latch includes a peripheral flange provided therein to selectively engage into the peripheral groove of the pin of the plate of the gardening tool, and to detachably latch the gardening tool to the base.

The latch includes at least one orifice formed therein for receiving the pin of the gardening tool, and at least one aperture formed therein and communicating with the orifice thereof and defined by the peripheral flange, the peripheral flange is provided to selectively engage into the peripheral groove of the pin of the plate of the gardening tool.

The latch includes a channel formed therein, the base includes a guide member secured thereto and slidably received in the channel of the latch, to guide the latch to move relative to the base. The latch includes a knob provided thereon for moving the latch relative to the base.

The base includes a bore formed therein, and a hand grip slidably engaged through the bore of the base. The gardening tool includes a board slidably attached thereto, and a rod extended from the board and moved in concert with the board, and secured to the hand grip, to allow the board and the rod to be operated by the hand grip. The gardening tool includes at least one tine extended from the plate, the board is slidably engaged onto the tine.

The base includes a handle attached thereto and having an aperture formed therein to slidably receive the hand grip. The handle includes a root portion attached to the base, the latch includes a space formed therein to receive the root portion of the handle.

The latch includes an opening formed therein, the base includes a stop secured thereto and slidably received in the opening of the latch, to guide the latch to move relative to the base. The base includes a cavity formed therein, the stop includes a tongue having a projection extended therefrom, and engageable into the cavity of the base, to anchor the stop to the base.

The stop includes a panel having a flap extended therefrom, and the tongue is extended from the flap. The stop includes a conduit engaged onto the base, and secured to the base with a fastener.

A spring biasing device may further be provided for biasing the latch relative to the base, and includes a spring attached to the base and engaged with the latch, to bias and to move the latch relative to the base. The latch includes at least one extension extended therefrom, and engaged with the spring which may bias and move the latch relative to the base. The spring may be engaged onto the conduit of the stop.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an agricultural device in accordance with the present invention;

FIG. 2 is a perspective view of the agricultural device;

FIG. 3 is a partial cross sectional view of the agricultural device, taken along lines 3-3 of FIG. 2;

FIG. 4 is a partial top plan view of the agricultural device;

FIG. 5 is a partial cross sectional view taken along lines 5-5 of FIG. 4;

FIG. 6 is a partial top plan view similar to FIG. 4, illustrating the operation of the agricultural device; and

FIG. 7 is a partial cross sectional view similar to FIG. 5, illustrating the operation of the agricultural device.

### DETAILED DESCRIPTION OF THE PREFERRED EMBODIMENT

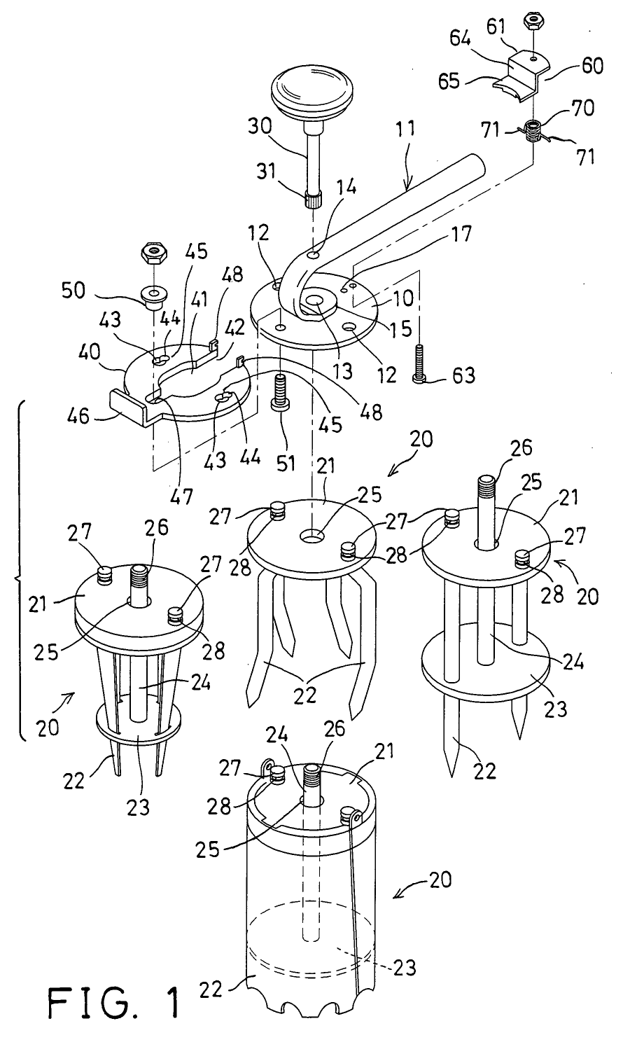

Referring to the drawings, and initially to FIGS. 1-3, an agricultural device in accordance with the present invention comprises a plate or a base 10, and a handle 11 attached or secured to the base 10, for carrying or moving the base 10. The base 10 includes one or more, such as two opposite orifices 12 formed therein, and a bore 13 formed therein, such as formed in the center portion thereof, and a cavity 17 formed therein.

The handle 11 includes an aperture 14 formed therein, and aligned with the bore 13 of the base 10, for slidably receiving a hand grip 30. The hand grip 30 includes a fastener or a lock nut 31 attached to the bottom portion thereof, for attaching to one or more gardening tools 20, in order to actuate or operate the gardening tools 20, which will be described in further details hereinafter.

Each of the gardening tools 20 includes one or more pawls or tines 22 extended from a plate 21, a board 23 slidably attached to the tines 22 and movable up and down along the tines 22, and a rod 24 extended from or secured to the board 23 and moved in concert with the board 23 and slidably engaged through a bore 25 of the plate 21. The rod 24 includes an outer thread 26 for securing to the hand grip 30 with the lock nut 31, to allow the tines 22 and the board 23 and the rod 24 to be operated by the hand grip 30.

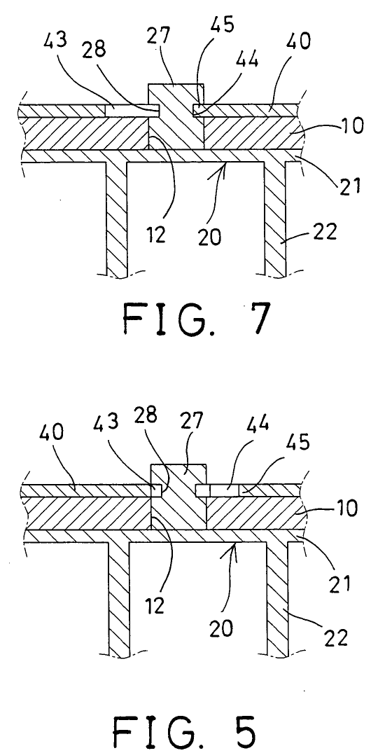

Each of the gardening tools 20 includes one or more such as two opposite pins 27 extended from the plate 21, and engageable through the orifices 12 of the base 10 respectively, and to be detachably secured to the base 10 with a latch 40. Each of the pins 27 includes a peripheral groove 28 formed therein and exposable out of the base 10 when the plate 21 is engaged onto the base 10 (FIGS. 5, 7).

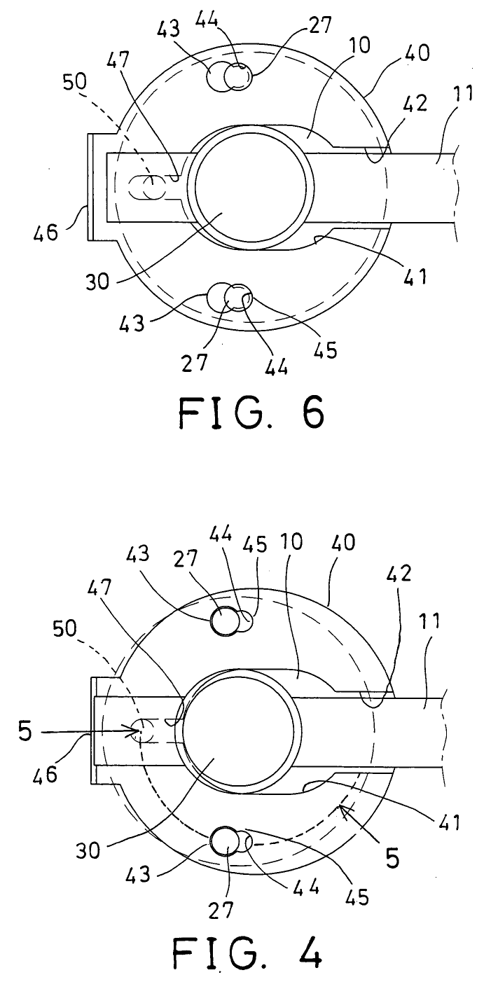

The latch 40 includes a space 41 having an opening 42 formed therein for slidably receiving a root portion 15 of the handle 11, one or more, such as two opposite orifices 43 formed therein for receiving the pins 27 of the gardening tools 20 respectively (FIGS. 4, 5), and one or more, such as two opposite apertures 44 formed therein and communicating with the orifices 43 of the latch 40 respectively, and each defined by a peripheral flange 45, best shown in FIG. 1.

The apertures 44 of the latch 40 include an inner diameter smaller than that of the orifices 43 of the latch 40 respectively, and smaller than the outer diameter of the pins 27 respectively. The peripheral flanges 45 of the latch 40 are arranged to be engaged into the peripheral grooves 28 of the pins 27 and engaged with the pins 27 respectively (FIGS. 6, 7), when the latch 40 is moved relative to the base 10, in order to detachably latch or secure or anchor the gardening tools 20 to the base 10 respectively.

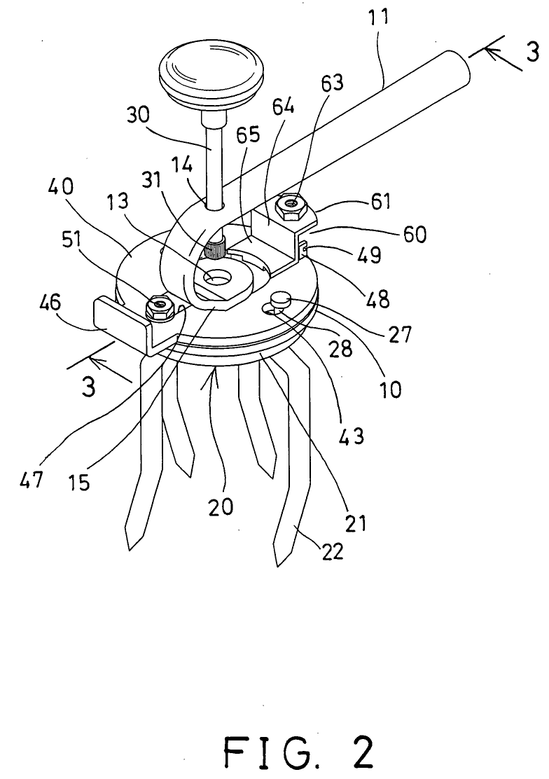

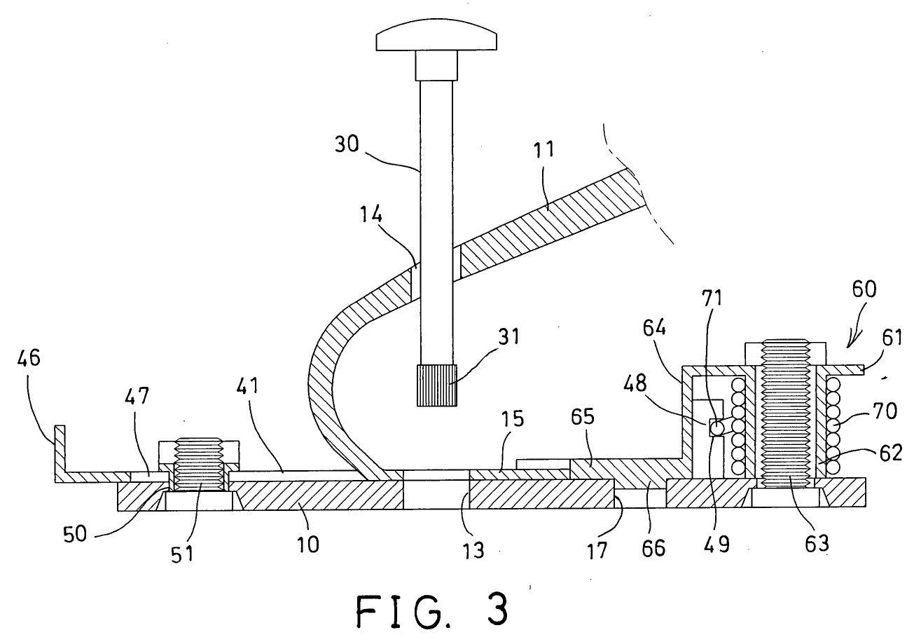

The latch 40 includes a knob 46 provided thereon or extended therefrom for moving the latch 40 relative to the base 10 and the gardening tools 20, and includes a channel 47 formed therein and communicating with the space 41 of the latch 40, and includes one or more, such as two extensions 48 provided thereon or extended therefrom. Each of the extensions 48 includes a depression 49 formed therein (FIGS. 2, 3).

A guide member 50 is secured to the base 10 with such as a fastener 51, and is slidably engaged in the channel 47 of the latch 40, to guide the latch 40 to be smoothly moved relative to the base 10. A stop 60 includes a panel 61, and a conduit 62 extended from the panel 61 and engaged onto the base 10, and secured to the base 10 with such as a fastener 63, and slidably received in the opening 42 of the latch 40, to further guide the latch 40 to be smoothly moved relative to the base 10.

The stop 60 includes a flap 64 extended downwardly from the panel 61, and a tongue 65 extended from the bottom portion of the flap 64 and also slidably received in the opening 42 of the latch 40, to further guide the latch 40 to be smoothly moved relative to the base 10. The stop 60 includes a projection 66 extended downwardly from the tongue 65 (FIG. 3) and engageable into the cavity 17 of the base 10, to anchor the stop 60 to the base 10.

As shown in FIGS. 1 and 3, a spring member 70 may further be provided and attached to the stop 60, such as engaged onto the conduit 62 of the stop 60, and includes two ends 71 engaged into the depressions 49 of the extensions 48 of the latch 40 respectively (FIG. 3), to bias and to move the latch 40 relative to the base 10, in order to force the peripheral flanges 45 of the latch 40 to engage into the peripheral grooves 28 of the pins 27, so as to detachably latch or secure or anchor the gardening tools 20 to the base 10 respectively.

The latch 40 may then be moved relative to the base 10 again with such as the knob 46, to disengage the peripheral flanges 45 of the latch 40 from the peripheral grooves 28 of the pins 27, and so as to detach the gardening tools 20 to the base 10 when required.

In operation, the user may select one of the gardening tools 20, and/or move the latch 40 relative to the base 10, in order to align the orifices 43 of the latch 40 with the orifices 12 of the base 10 respectively, and to allow the pins 27 of the plate 21 to engage through the orifices 12 of the base 10 respectively. The latch 40 may then be moved relative to the base 10 with such as the knob 46 or by the spring 70, to engage the peripheral flanges 45 of the latch 40 into the peripheral grooves 28 of the pins 27, and thus to latch the gardening tools 20 to the base 10.

The gardening tools 20 may thus be quickly and selectively and easily attached to the base 10 with the latch 40, and may thus be quickly changed or replaced with the other ones. When it is required to disengage the gardening tools 20 from the base 10, it is only required to pull the knob 46 and to move the latch 40 relative to the base 10, and to disengage the peripheral flanges 45 of the latch 40 from the peripheral grooves 28 of the pins 27, such that the gardening tools 20 may be quickly changed or replaced with the other ones.

Accordingly, the agricultural device in accordance with the present invention includes one or more gardening tools that may be easily changed or replaced with the other ones.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. An agricultural device comprising:
a base including at least one orifice formed therein,
a gardening tool including a plate having at least one pin extended therefrom, and engageable through said at least one orifice of said base, and
a latch to detachably latch said gardening tool to said base, and thus to secure said gardening tool to said base.

2. The agricultural device as claimed in claim 1, wherein said at least one pin of said plate of said gardening tool includes a peripheral groove formed therein, said latch includes a peripheral flange provided therein to selectively engage into said peripheral groove of said at least one pin of said plate of said gardening tool, and to detachably latch said gardening tool to said base.

3. The agricultural device as claimed in claim 2, wherein said latch includes at least one orifice formed therein for receiving said at least one pin of said gardening tool, and at least one aperture formed therein and communicating with said at least one orifice thereof and defined by said peripheral flange, said peripheral flange is provided to selectively engage into said peripheral groove of said at least one pin of said plate of said gardening tool.

4. The agricultural device as claimed in claim 1, wherein said latch includes a channel formed therein, said base includes a guide member secured thereto and slidably received in said channel of said latch, to guide said latch to move relative to said base.

5. The agricultural device as claimed in claim 1, wherein said latch includes a knob provided thereon for moving said latch relative to said base.

6. The agricultural device as claimed in claim 1, wherein said base includes a bore formed therein, and a hand grip slidably engaged through said bore of said base.

7. The agricultural device as claimed in claim 6, wherein said gardening tool includes a board slidably attached thereto, and a rod extended from said board and moved in concert with said board, and secured to said hand grip, to allow said board and said rod to be operated by said hand grip.

8. The agricultural device as claimed in claim 7, wherein said gardening tool includes at least one tine extended from said plate, said board is slidably engaged onto said at least one tine.

9. The agricultural device as claimed in claim 6, wherein said base includes a handle attached thereto and having an aperture formed therein to slidably receive said hand grip.

10. The agricultural device as claimed in claim 9, wherein said handle includes a root portion attached to said base, said latch includes a space formed therein to receive said root portion of said handle.

11. The agricultural device as claimed in claim 1, wherein said latch includes an opening formed therein, said base includes a stop secured thereto and slidably received in said opening of said latch, to guide said latch to move relative to said base.

12. The agricultural device as claimed in claim 11, wherein said base includes a cavity formed therein, said stop includes a tongue having a projection extended therefrom, and engageable into said cavity of said base, to anchor said stop to said base.

13. The agricultural device as claimed in claim 12, wherein said stop includes a panel having a flap extended therefrom, and said tongue is extended from said flap.

14. The agricultural device as claimed in claim 11, wherein said stop includes a conduit engaged onto said base, and secured to said base with a fastener.

15. The agricultural device as claimed in claim 1 further comprising means for biasing said latch relative to said base.

16. The agricultural device as claimed in claim 15, wherein said biasing means includes a spring attached to said base and engaged with said latch, to bias and to move said latch relative to said base.

17. The agricultural device as claimed in claim 16, wherein said latch includes at least one extension extended therefrom, and engaged with said spring which may bias and move said latch relative to said base.

18. The agricultural device as claimed in claim 16, wherein said base includes a conduit secured thereto, and said spring is engaged onto said conduit.
